(19) United States
(12) Patent Application Publication
(10) Pub. No.: US 2005/0200253 A1
(43) Pub. Date: Sep. 15, 2005

(54) Spring biased latching arrangement for a refrigerator door

(76) Inventors: John Wissinger, Gregory, MI (US); Carl Onken JR., West Chester, OH (US); Kevin Stover, Troy, OH (US)

Correspondence Address: HARNESS, DICKEY & PIERCE, P.L.C., P.O. BOX 828, BLOOMFIELD HILLS, MI, 48303, US

(21) Appl. No.: 10/798,933

(22) Filed: Mar. 11, 2004

(51) Int. Cl. E05C 3/06

(52) U.S. Cl. 312/405; 312/296

(57) ABSTRACT

A latching arrangement for a refrigerator positively latches a door of the refrigerator. The refrigerator includes a housing. The door pivotally coupled to the housing. A striker is connected to the housing. The latching arrangement is carried by the door. The latching arrangement includes a handle and a pawl. The handle is connected to the door for movement between a first position and a second position. The handle defining at least one cam surface. The pawls is connected to the door for movement between a latched position engaged with the striker for securing the door in a closed position and an unlatched position allowing the door to be pivoted from the closed position. The pawl includes a cam follower that cooperates with the at least one cam surface such that movement of the handle from the first position to the second position moves the pawl from the latched position to the unlatched position. The latch is partly or completely concealed in the door edge.

### FIELD OF THE INVENTION

The present invention relates to latching mechanisms, and more particularly, to a spring biased latching arrangement having a latch pivotable about an axis for use with a refrigerator door.

### BACKGROUND OF THE INVENTION

Refrigerators for use in recreational vehicles require a positive latching to keep the doors closed when the vehicle is in motion. Commonly, many such refrigerators have a handle on the top or front of the door that requires the user to first slide a catch and then pull the handle to open the door, or to rotate or otherwise manipulate the handle to open the door, in a manner which is different from the opening of a door of a home refrigerator which need not be positively latched. Thus, users often perceive a difference between a refrigerator for a recreational vehicle as compared to a residential refrigerator due to the extra steps or different motion required for door opening. An effort has been made in the pertinent art to make refrigerators and other conveniences for recreational vehicles as “home-like” as possible. Accordingly, a need exists for a latching mechanism for a refrigerator for use in a vehicle which provides users with a positive latching arrangement that is substantially transparent to the user and thereby more similar to a home refrigerator.

### SUMMARY OF THE INVENTION

In one form, the present invention provides latching arrangement for a refrigerator. The refrigerator includes a housing, a door pivotally coupled to the housing, and a striker connected to the housing. The latching arrangement is carried by the door. The latching arrangement includes a handle and a pawl. The handle is connected to the door for movement between a first position and a second position. The handle defines at least one cam surface. The pawl is connected to the door for movement between a latched position and an unlatched position. In the latched position, the pawl is engaged with the striker for securing the door in a closed position. In the unlatched position the pawl allows the door to be pivoted from the closed position. The pawl includes a cam follower that cooperates with at least one cam surface such that movement of the handle from the first position to the second position moves the pawl from the latched position to the unlatched position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a refrigerator incorporating a latching arrangement constructed in accordance with the teachings of the present invention;

FIG. 2 is an enlarged perspective view of a portion of the refrigerator of FIG. 1;

FIG. 3 is an exploded perspective view of the spring biased latching arrangement of the present invention and an associated mounting portion of the refrigerator;

FIG. 4 is a cross-sectional plan view along section line 4-4 of FIG. 2 showing the latching arrangement in a latched position; and

FIG. 5 is a cross-sectional view of the spring biased latching arrangement shown in FIG. 2 in an unlatched position.

### DETAILED DESCRIPTION OF THE PREFERRED EMBODIMENTS

The following description of the preferred embodiments is merely exemplary in nature and is in no way intended to limit the invention, its application, or uses.

The present invention is generally related to a latching arrangement for use in a recreational vehicle or other vehicle (e.g., train, boat, airplane or the like) in which positive latching is required during vehicle operation. In this regard, the latching arrangement will be described in the context of a refrigerator for use in a recreational vehicle. In the exemplary embodiment illustrated throughout the drawings, the refrigerator is of the type having a top freezer and a bottom refrigerator section, but the present invention is equally applicable to any other type of refrigerator configuration. Furthermore, it is to be understood that the principles embodied herein are equally applicable to other types of appliances in general and to other types of appliances used in motor vehicles as well.

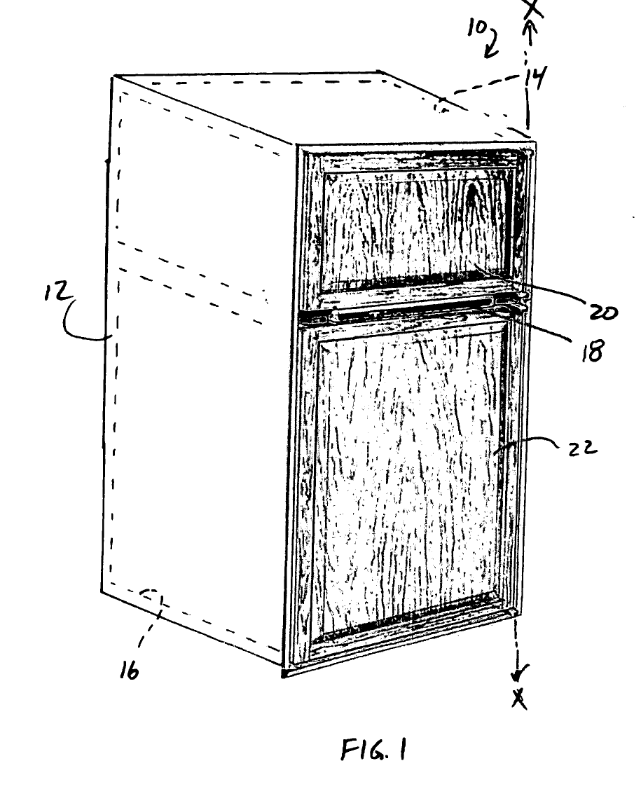

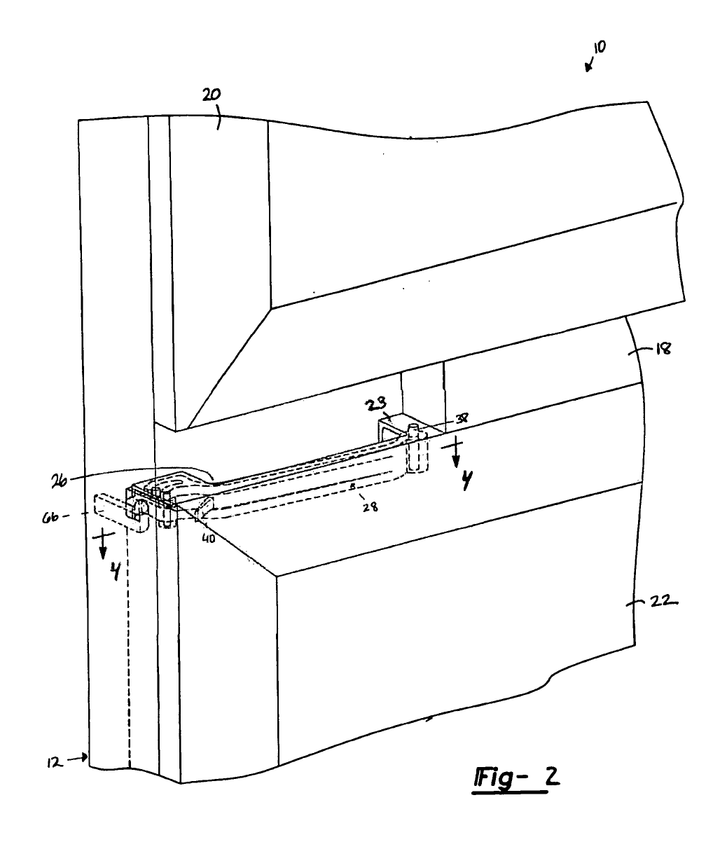

Referring first to FIGS. 1 and 2, a refrigerator 10 for use in a recreational vehicle is shown. The refrigerator 10 is shown to generally include a housing 12. In one embodiment, the refrigerator 10 defines a freezer section or compartment 14 and a refrigerator section or compartment 16. The freezer section 14 is shown positioned above the refrigerator section 16. The refrigerator 10 may further include a control panel 18 situated between the freezer section 14 and refrigerator section 16. In a known manner, the control panel 18 provides temperature controls for the freezer 14 and refrigerator section 16. The freezer section 14 and refrigerator section 16 are accessible through upper and lower doors 20 and 22, respectively. The doors 20,22 are conventionally mounted to the housing 12 for rotation about a vertically extending pivot axis X between closed positions (shown in FIG. 1, for example) and open positions (not specifically shown).

A latching arrangement 24 in accordance with an embodiment of the present invention is carried by each of the doors 20 and 22. As will become more apparent below, the latching arrangement 24 permits the associated door 20 or 22 to be positively latched, as well as easily opened to allow access to the storage compartment. As used herein, the term “positively latched” will be understood to refer to a secured condition in which movement of an element is required prior to opening of the door 22.

In one embodiment, the latching arrangement 24 may be disposed at the bottom of the door 20 of the freezer section 14 and at the top of the door 22 of the refrigerator section 16 so as to place them adjacent to each other. The remainder of this detailed description will focus on the latching arrangement 24 for the lower door 22. It will be understood that the upper door 20 may employ a substantially identical latching arrangement. The only difference between the implementation of the latching arrangement 24 for the refrigerator section 16 and the freezer 14 being the orientation of an accommodating recess 26. Thus, the latching arrangement 24 for the door 20 of the freezer 14 has not been shown.

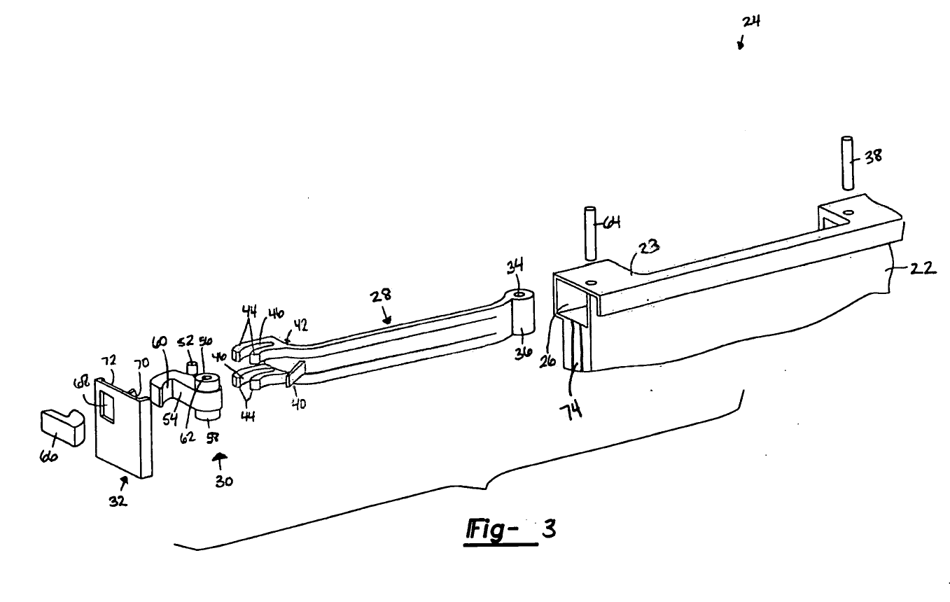

With continued reference to FIGS. 1 and 2 and additional reference to FIGS. 3 through 5, the latching arrangement 24 of the present invention will be described in greater detail. The door includes a side defining a recess 26. In the embodiment illustrated, the door 22 is shown to include a cap portion 23. The cap portion 23 defines the recess or opening 26. The latching arrangement 24 is substantially disposed within this recess 26 of the door 22. As will become apparent, location of the latching arrangement 24 within the recess 26 makes the latching arrangement 24 substantially hidden when the door 22 is closed. It will be appreciated by those skilled in the art that the recess may be alternatively provided in the bottom side or a lateral side of the door 22.

The latching arrangement 24 generally includes a door handle 28, a door pawl 30 and an end cap or housing 32. In one particular application, the door handle 28 is made from a rigid plastic. However, the door handle 28 may be constructed of any material having suitable strength and durability characteristics. The door handle 28 includes an opening 34 at a first end 36 for receipt of a handle shoulder screw 38 therethrough. The handle shoulder screw 38 pivotally couples the first end 36 of the door handle 28 to a mounting location within the recess 26 in the door 22. Although a shoulder screw is used in the illustrated embodiment, it will be understood that other fastening mechanisms may be used to rotatably couple the door handle 28 to the recess 26 in the door 22. In this regard, a pin or other structure may be alternatively used for pivotal coupling.

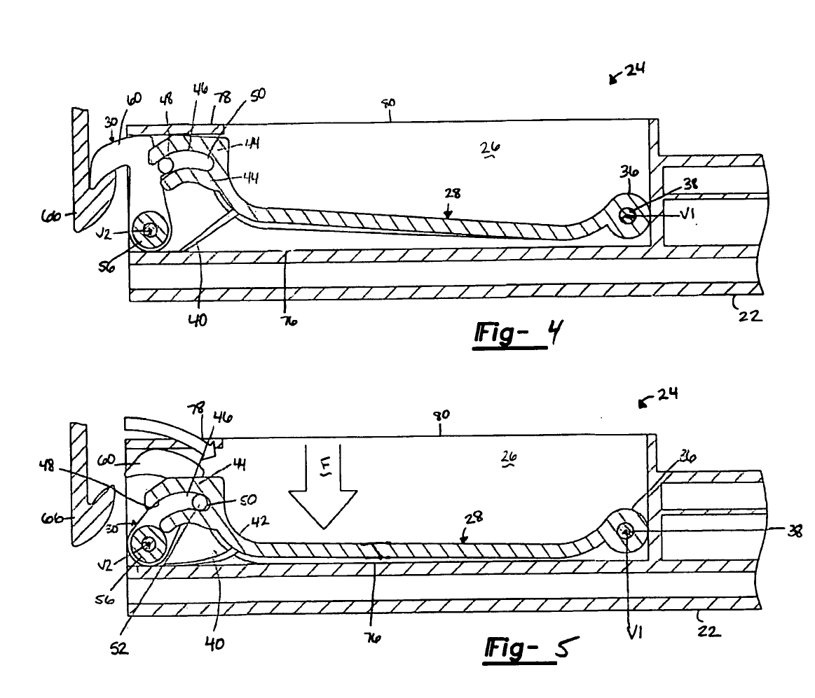

The door handle 28 is coupled to the door 22 for rotation about the screw 38. Explaining further, the screw 38 defines an axis V1 about which the door handle 28 is movable between a first position and a second position. The first position is shown in FIG. 4. The second position is shown in FIG. 5. In the embodiment illustrated, the axis defined by the screw 38 is generally vertical. On a lateral side application, the axis of the screw is vertical.

The door handle 28 also includes a biasing member 40. The biasing member may be in the form of a leaf spring 40 located proximate a second end 42 of the handle 28. The leaf spring 40 is carried by the door handle 28 in a predetermined location. In one application, the leaf spring 40 is integrally formed with the remainder of the door handle 28. The leaf spring 40 may also be formed as a discrete part from plastic or metal and attached to the door handle 28 in any manner well known in the art. Suitable methods of attachment include, but are not limited to, welding and adhesive bonding. The biasing member 40 biases the handle 28 about the screw 38 to the first position.

The door handle further includes two pairs of slotted fingers 44 located adjacent to the leaf spring 40 proximate the second end 42 of the door handle 28. The pairs of slotted fingers 44 are spaced apart at the second end 42 of the handle 28 by a distance substantially equal to the thickness of the door pawl 30. The pairs of slotted fingers 44 cooperate to define a parallel curved or arcuate slot 46 therebetween which engages a portion of the door pawl 30. Explaining further, the inner surfaces of the slot 46 define cam surfaces for cooperating with the pawl 30. The curved slots 46 each have a first end 48 which curves down to a second end 50 as best shown in FIG. 4. The first ends 48 of the curved slots 46 are in engagement with the door pawl 30 when the door 22 is closed. When the door handle 28 is engaged, the second ends 50 of the curved slots 46 engage the door pawl 30 to unlatch the door 22.

With particular reference to FIG. 3, the door pawl 30 has a cylindrical post or cam follower 52 formed with a main body 54. The cylindrical post 52 of the door pawl 30 slides between the first ends 48 and second ends 50 of the curved slots 46 in the pairs of slotted fingers 44 of the door handle 28. Engagement of the cylindrical post 52 with the curved slots 46 of the door handle 28 permits the door pawl 30 to rotate only when the door handle 28 is rotated, as will be discussed later.

The main body 54 of the door pawl 30 further includes a first boss 56, a second boss 58 and a hook 60. The first boss 56 and second boss 58 define an opening 62 through the main body 54 for receipt of a pawl shoulder screw 64 therethrough. The pawl shoulder screw 64 pivotally couples the door pawl 30 to the door 22 for movement about a vertical axis V2 (shown in FIGS. 4 and 5). The pawl 30 is movable from a latched position. Although a shoulder screw is used in this embodiment, it will again be understood that other fastening mechanisms may be used to rotatably couple the door pawl 30 to the recess 26 in the door 22, such as, for example, a pin.

The hook 60 engages a fixed cabinet receiver or striker 66 to secure the door 22 to the cabinet 12 in the closed position as shown in FIG. 4. Due to the cooperating shape and orientation of both the hook 60 of the door pawl 30 and the cabinet receiver 66, centrifugal force applied to the door 22 that frequently results during vehicle transit, urges the hook 60 against the cabinet receiver 66. This relationship prevents the door 22 from unintentionally opening during transit. As particularly shown in FIG. 5, when the door handle 28 is engaged, the hook 60 is disengaged from the cabinet receiver 66, and the door 22 is free to be opened. Thus, the mating surface between the hook 60 and cabinet receiver 66 is configured such that the hook 60 can rotatably disengage from the cabinet receiver 66 upon rotation of the door handle 28. The hook 60 of the door pawl 30 further extends through the end housing 32 as best shown in FIGS. 2 and 3.

The end housing 32 has an opening 68 through which the hook 60 of the door pawl 30 extends. The end housing 32 has a first slot 70 and a second slot 72 which both snap fit to a side edge 74 of the recess 26 to secure the end housing 32 to the recess 26. The end housing 32 conceals the remainder of the latching arrangement 24 when the door 22 is open.

When the door 22 is closed, as shown in FIG. 4, the cabinet receiver 66 is engaged with the hook 60 of the door pawl 30. The door handle 28 is displaced from a front edge 76 of the recess 26 by the leaf spring 40 such that the pairs of slotted fingers 44 abut a stop 78 located at a back edge of the recess 26. The leaf spring 40 keeps the door handle 28 urged against the stop 78, which in turn applies a constant force on the door handle 28 that prevents the door handle 28 from moving and vibrating during the operation of the vehicle. This constant force also ensures that the hook 60 stays engaged with the cabinet receiver 66. In addition, the pairs of slotted fingers 44 of the door handle 28 are positively engaged with the door pawl 30. More specifically, the cylindrical post 52 of the door pawl 30 is disposed in the first ends 48 of the curved slots 46 formed in the pairs of slotted fingers 44.

With particular reference to FIG. 5, the door 22 is opened by depressing the door handle 28 to overcome the biasing force of the leaf spring 40. In particular, a force F must be applied to the door handle 28 sufficient enough to cause the door handle 28 to rotate about the vertical axis V1, defined by the handle shoulder screw 38, such that the door handle 28 is moved into a position adjacent to the front edge 76 of the recess 26. As the force F is applied to the door handle 28, the leaf spring 40 is depressed and the cylindrical post 52 of the door pawl 30 slides from the first ends 48 of the curved slots 46 in the pairs of slotted fingers 44 to the second ends 50. The motion of the cylindrical post 52 through the curved slots 46 causes the door pawl 30 to rotate about the vertical axis V2 defined by the pawl shoulder screw 64, and subsequently causes the main body 54 of the door pawl 30 to partially pass through the pairs of slotted fingers 44. In this manner, movement of the handle 28 from the first position to the second position functions to move the pawl 30 from the latched position to the unlatched position. The rotation of the door pawl 30 disengages the hook 60 from the cabinet receiver 66, releasing the door 22. When the door handle 28 is adjacent to the front edge 76 of the recess 26, the hook 60 is adjacent to the stop 78 on the back edge 80 of the recess 26.

Thus, for a user to open the door 22, the fingers of a hand are inserted into the recess 26 and the door handle 28 is pulled towards him/her against the force of the leaf spring 40. Once the door 22 is open, the user can cease to compress the door handle 28, and the integral leaf spring 40 will force the door handle 28 away from the front edge 76 of the recess 26, and allow the hook 60 of the door pawl 30 to re-engage the cabinet receiver 66 when the door 22 is closed. The concealed door handle 28 provides a smoother, aesthetically pleasing look to the doors 20, 22 and permits the space between the freezer 14 and refrigerator section 16 to be narrower. This in turn increases the capacity of the freezer 14 and refrigerator section 16. The narrow space also enables a smaller and sleeker control panel 18 to be implemented.

The description of the invention is merely exemplary in nature and, thus, variations that do not depart from the gist of the invention are intended to be within the scope of the invention. Such variations are not to be regarded as a departure from the spirit and scope of the invention.

1. A refrigerator comprising:
a housing;
a door pivotally coupled to the housing;
a striker connected to the housing; and
a latching arrangement carried by the door, the latching arrangement including:
a handle connected to the door for movement between a first position and a second position, the handle defining at least one cam surface; and
a pawl connected to the door for movement between a latched position engaged with the striker for securing the door in a closed position and an unlatched position allowing the door to be pivoted from the closed position, the pawl including a cam follower that cooperates with the at least one cam surface such that movement of the handle from the first position to the second position moves the pawl from the latched position to the unlatched position.

2. The refrigerator of claim 1, wherein the handle is pivotally connected to the door for rotation about a first pivot axis.

3. The refrigerator of claim 2, wherein the pawl is pivotally connected to the door for rotation about a second pivot axis.

4. The refrigerator of claim 3, wherein the first and second pivot axes are spaced apart from one another.

5. The refrigerator of claim 3, wherein the first and second pivot axes are parallel to one another.

6. The refrigerator of claim 3, wherein the first and second pivot axes are vertically extending pivot axes.

7. The refrigerator of claim 1, wherein the latching arrangement includes a biasing element carried by the handle for biasing the handle to the first position.

8. The refrigerator of claim 7, wherein the biasing element is integrally formed with the handle.

9. The refrigerator of claim 1, wherein the handle includes a slot, the slot defining the at least one cam surface.

10. The refrigerator of claim 9, wherein the slot is an arcuate slot.

11. The refrigerator of claim 9, wherein the slot is defined by at least a pair of fingers.

12. The refrigerator of claim 1, wherein the latching arrangement is located at an edge of the door.

13. The refrigerator of claim 1, wherein the latching arrangement is substantially disposed within a recess of the door and substantially hidden from view.

14. The refrigerator of claim 1, wherein the refrigerator is for a motor vehicle.

15. A latching arrangement for a refrigerator having a housing, a door pivotally coupled to the housing and a striker connected to the housing, the latching arrangement comprising:
a handle for connection to the door for movement between a first position and a second position, the handle defining at least one cam surface; and
a pawl for connection to the door for movement between a latched position engaged with the striker for securing the door in a closed position and an unlatched position allowing the door to be pivoted from the closed position, the pawl including a cam follower that cooperates with the at least one cam surface such that movement of the handle from the first position to the second position moves the pawl from the latched position to the unlatched position.

16. The refrigerator of claim 15, wherein the latching arrangement includes a biasing element carried by the handle for biasing the handle to the first position.

17. The refrigerator of claim 16, wherein the biasing element is integrally formed with the handle.

18. The refrigerator of claim 15, wherein the handle includes a slot, the slot defining the at least one cam surface.

19. The refrigerator of claim 18, wherein the slot is an arcuate slot.

20. The refrigerator of claim 18, wherein the slot is defined by at least a pair of fingers.

21. A refrigerator comprising:
a housing;
a door pivotally coupled to the housing, the door including a side, the side defining recess;
a striker connected to the housing; and
a latching arrangement carried by the door, the latching arrangement including:
a handle connected to the door for movement between a first position and a second position, the handle substantially disposed in the recess; and
a pawl connected to the door for movement between a latched position engaged with the striker for securing the door in a closed position and an unlatched position allowing the door to be pivoted from the closed position, the pawl cooperating with the handle.

22. The refrigerator of claim 21, wherein the handle is pivotally connected to the door for rotation about a first pivot axis.

23. The refrigerator of claim 22, wherein the pawl is pivotally connected to the door for rotation about a second pivot axis.

24. The refrigerator of claim 23, wherein the first and second pivot axes are spaced apart from one another.

25. The refrigerator of claim 23, wherein the first and second pivot axes are parallel to one another.

26. The refrigerator of claim 23, wherein the first and second pivot axes are vertically extending pivot axes.

27. The refrigerator of claim 21, wherein the side is a top side.

28. The refrigerator of claim 21, wherein the handle is at least partly concealed by a perimeter of the door.
